(19) United States
(12) Patent Application Publication
(10) Pub. No.: US 2015/0356541 A1
(43) Pub. Date: Dec. 10, 2015

(54) ELECTRONIC RECEIPT MANAGEMENT SERVER, MERCHANDISE SALES DATA PROCESSING APPARATUS, PRINT CONTROL APPARATUS, AND PROGRAM

(71) Applicant: TOSHIBA TEC KABUSHIKI KAISHA, Tokyo (JP)

(72) Inventors: Keiichi HASEGAWA, Koto Tokyo (JP); Koichi SUGIYAMA, Izunokuni Shizuoka (JP); Tsuyoshi GOTANDA, Ota Tokyo (JP)

(21) Appl. No.: 14/733,599

(22) Filed: Jun. 8, 2015

(30) Foreign Application Priority Data
Jun. 10, 2014 (JP) 2014-119809
Sep. 3, 2014 (JP) 2014-179526

(51) Int. Cl. G06Q 20/20; G06Q 20/32

(52) U.S. Cl. CPC G06Q 20/209; G06Q 20/3224

(57) ABSTRACT

A server includes a communication unit and a processing unit. The communication unit is configured to receive electronic receipt data from a store server and a setting that indicates whether or not a mark representing that an electronic receipt has been stamped is to be overlaid on the electronic receipt to be displayed on a mobile computing device. The processing unit is configured to generate display data from the electronic receipt data according to the setting, and transmit the display data to a mobile computing device correlated to a user code included in the electronic receipt data. The display data generated by the processing unit includes a first portion corresponding to the display data of the electronic receipt, and, if the setting indicates that the mark is to be overlaid on the electronic receipt, also a second portion corresponding to the display data of the mark.

### CROSS-REFERENCE TO RELATED APPLICATION

This application is based upon and claims the benefit of priority from Japanese Patent Application No. 2014-119809, filed Jun. 10, 2014 and Japanese Patent Application No. 2014-179526, filed Sep. 3, 2014; the entire contents of both applications are incorporated herein by reference.

### FIELD

Embodiments described herein relate generally to an electronic receipt management server, a merchandise sales data processing apparatus, a print control apparatus, and a program.

### BACKGROUND

One type of an electronic receipt system transmits electronic data of a purchase transaction at a store (i.e., an electronic receipt) to a computing device of a customer, such as a mobile device, instead of issuing a conventional paper receipt that is handed to the customer upon completion of the purchase transaction.

The electronic receipt is useful to the customer, because the customer can manage his or her purchase transactions electronically. Further, the electronic receipt is useful to the store, because the store can reduce paper usage and with full conversion, will not need to invest in machines that issue the paper receipt. In addition, providing electronic receipts instead of paper receipts may reduce the time necessary to carry out settlement processing for the purchase transaction.

Conventionally, a mark is stamped on the paper receipt to indicate certain processing related to the purchase transaction (e.g., return of purchased product and provision of a reward) has been carried out. It would be convenient to the customer and the store if a similar processing can be carried out for electronic receipts.

### DESCRIPTION OF THE DRAWINGS

FIG. 1 illustrates an entire configuration of an electronic receipt system according to a first embodiment.

FIG. 2 is a block diagram of a POS terminal in the electronic receipt system.

FIG. 3 is a block diagram of an electronic receipt server in the electronic receipt system.

FIG. 4 is a block diagram of an electronic receipt management server in the electronic receipt system.

FIG. 5 illustrates an example of a data structure of a stamp management table stored in the electronic receipt management server.

FIG. 6 is a block diagram of a portable terminal in the electronic receipt system.

FIG. 7 illustrates functional blocks of the POS terminal generated for electronic receipt.

FIG. 8 illustrates an example of an image of receipt information.

FIG. 9 illustrates an example of electronic receipt information.

FIG. 10 is a flowchart illustrating a flow of the electronic receipt processing carried out by the POS terminal.

FIG. 11 is a flowchart illustrating a flow of electronic receipt management processing and information transmission processing carried out by the electronic receipt server.

FIG. 12 illustrates functional blocks of the electronic receipt management server generated for electronic receipt management processing and information transmission processing.

FIG. 13 is a flowchart illustrating a flow of the electronic receipt management processing and the information transmission processing carried out by the electronic receipt management server.

FIG. 14 illustrates functional blocks of the portable terminal generated for electronic receipt reception processing and electronic receipt displaying processing.

FIG. 15 is a flowchart illustrating a flow of the electronic receipt reception processing and the electronic receipt displaying processing carried out by the portable terminal.

FIG. 16 illustrates an example of an image of return electronic receipt information displayed on a display unit of the portable terminal.

FIG. 17 illustrates screen transition of screens displayed on the POS terminal for stamp processing according to a second embodiment.

FIGS. 18 and 19 each illustrates an example of an electronic receipt image displayed on a display unit of a portable terminal.

### DETAILED DESCRIPTION

In general, according to one embodiment, a server is connected to a plurality of store servers and mobile computing devices over a network and configured to generate display data for display units of the mobile computing devices. The server includes a communication unit and a processing unit. The communication unit is configured to receive electronic receipt data from a store server along with a setting that indicates whether or not a mark representing that an electronic receipt has been stamped is to be overlaid on the electronic receipt when the electronic receipt is displayed on a display unit of the mobile computing device. The processing unit is configured to generate display data from the electronic receipt data according to the setting, and transmit the display data to a mobile computing device correlated to a user code included in the electronic receipt data, for display by the mobile computing device. The display data generated by the processing unit includes a first portion corresponding to the display data of the electronic receipt, and, if the setting indicates that the mark is to be overlaid on the electronic receipt, also a second portion corresponding to the display data of the mark.

Hereinafter, exemplary embodiments will be described with reference to the accompanying drawings.

### First Embodiment

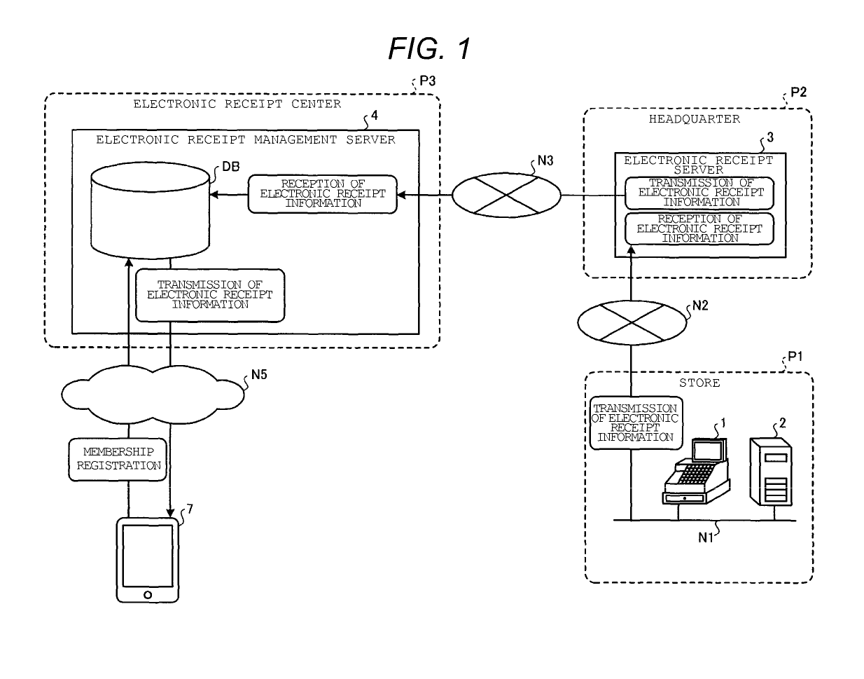

FIG. 1 illustrates an entire configuration of an electronic receipt system according to a first embodiment. As illustrated in FIG. 1, the electronic receipt system includes a point of sales (POS) terminal 1, a store server 2, an electronic receipt server 3, an electronic receipt management server 4, and a portable terminal 7.

The POS terminal 1 and the store server 2 are located in a store P1. The POS terminal 1 and the store server 2 are connected through a network N1 in the store P1, such as a local area network (LAN), so as to enable communication with each other. The POS terminal 1 and the store server 2 is configured to be connected to a network N2 which links the store P1 and a headquarter P2, through a network device (not illustrated) such as a router, which is connected to the network N1 in the store P1. The network N2 is, for example, a dedicated line such as the Internet and a virtual private network (VPN).

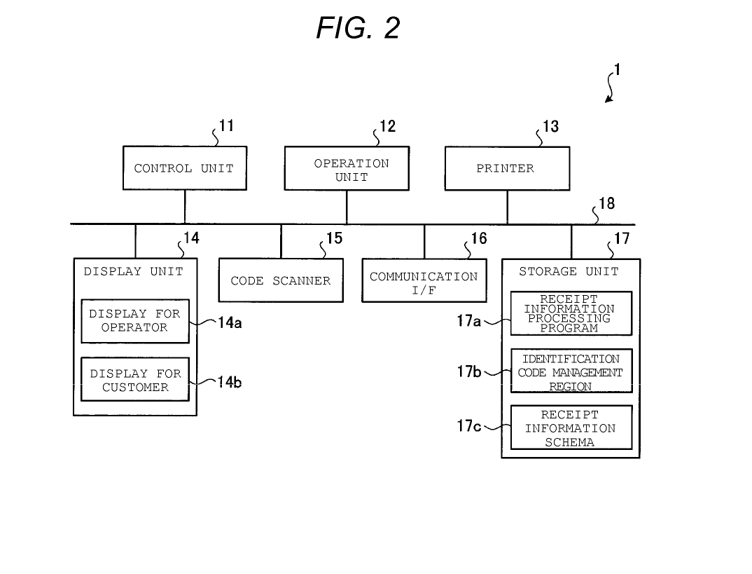

The POS terminal 1 is a merchandise sales data processing apparatus and executes merchandise sales data processing. The POS terminal 1 generates receipt information which includes details of a purchase transaction, causes a printer 13 (see FIG. 2) to print the generated receipt information and outputs a paper receipt. The POS terminal 1 outputs (transmits) electronic receipt information, which is obtained by converting a data format of the receipt information, to the electronic receipt server 3 through the network N2. A transmission method of the electronic receipt information is not particularly limited, and a general protocol such as HTTP and HTTPS may be used. The number of POS terminals 1 in the store P1 is not particularly limited, and may be plural.

The store server 2 generally manages processing performed by the POS terminal 1, such as merchandise sales data processing. For example, the store server 2 stores and manages merchandise sales data, which is generated through the merchandise sales data processing by the POS terminal 1, or stores and manages merchandise data files and the like, which are used during the merchandise sales data processing.

In this embodiment, the POS terminal 1 outputs electronic receipt information, but it is not limited thereto. For example, the store server 2 or a conversion apparatus (not illustrated) may convert a format of the receipt information generated by the POS terminal 1 into a certain data format, and the converted information may be output to the electronic receipt server 3 as the electronic receipt information.

The electronic receipt server 3 is located in the headquarter P2 of a company which operates one or more stores P1 or chain stores. The electronic receipt server 3 functions as a receipt management server for the company and manages electronic receipt information of the company. The electronic receipt server 3 has, for example, functions of performing operations, such as sales management, sales analysis, inventory management, and the like.

That is, the electronic receipt system may include a plurality of the electronic receipt servers 3, and each of the electronic receipt servers 3 may be provided for different one of a plurality of companies (retailers), such as convenience stores, grocery stores, and supermarkets.

The electronic receipt server 3 receives electronic receipt information transmitted from the POS terminal 1, through the network N2. The electronic receipt server 3 transmits the received electronic receipt information to the electronic receipt management server 4 through a network N3, which links the headquarter P2 and an electronic receipt center P3.

The network N3 is, for example, a dedicated line such as the Internet and a VPN. A transmission method of the electronic receipt information is not particularly limited, and a general protocol such as HTTP and HTTPS may be used.

The electronic receipt management server 4 is located in the electronic receipt center P3. The electronic receipt center P3 is, for example, a third party organization other than the companies which use the electronic receipt servers 3 to manage the electronic receipt information. Alternatively, the third party organization or the like may manage the electronic receipt server 3 as well as the electronic receipt management server 4.

The electronic receipt management server 4 functions as a receipt management server for customer, and collectively manages electronic receipt information of multiple companies, each of which operates one or more stores. The electronic receipt management server 4 stores and manages membership data in a membership master contained in a database DB. The membership data includes names or member codes of customers (members) who have completed membership registration, and transmission destination information (for example, mail address) associated with portable terminals 7 of the customers, as transmission destinations of the electronic receipt information. Alternatively, a membership management server or the like that stores and manages the membership data may be provided in the electronic receipt system separately from the electronic receipt management server 4.

The electronic receipt management server 4 receives electronic receipt information from the electronic receipt server 3, through the network N3. The electronic receipt management server 4 stores and manages the received electronic receipt information in an electronic receipt management region 43a, which is contained in the database DB. More specifically, the electronic receipt information includes a member code and the like in addition to details (merchandise sales data) of a purchase transaction, and is managed in correlation with membership data of a corresponding member.

If the electronic receipt information is stored in the database DB, the electronic receipt management server 4 specifies a transmission destination (portable terminal 7) based on transmission destination information correlated with a member code included in the electronic receipt information. The electronic receipt management server 4 then transmits the electronic receipt information stored in the database DB to the transmission destination through a network N5. When additional information is also correlated with the electronic receipt information, the additional information is also transmitted to the transmission destination.

If an inquiry of electronic receipt information, which includes a designated member code, is received from the portable terminal 7, which is connected through the network N5, the electronic receipt management server 4 extracts electronic receipt information corresponding to the designated member code from the database DB and transmits the extracted electronic receipt information to the portable terminal 7. When additional information is also correlated with the electronic receipt information, the additional information is also transmitted to the portable terminal 7 which has transmitted the inquiry.

The portable terminal 7 is a terminal apparatus carried and used by a user (customer) of the electronic receipt system, such as a smart phone, a mobile phone, a personal digital assistant (PDA), and a tablet computer, for example. The portable terminal 7 has an installed application for displaying various kinds of information provided on the network N5, such as a web browser. A terminal apparatus of a PC and the like may be used instead of the portable terminal 7.

The portable terminal 7 accesses the electronic receipt management server 4 through the network N5, and performs membership registration to the electronic receipt system. The network N5 is the Internet or various public networks.

The membership registration of a customer to the electronic receipt system is performed through the following procedures, for example. A customer transmits a blank mail from the portable terminal 7 to the electronic receipt management server 4 through the network N5. The electronic receipt management server 4 transmits a Uniform Resource Locator (URL) of a webpage for membership registration to a mail address of the received mail. The customer accesses the webpage for membership registration through the portable terminal 7 using the received URL and causes an input screen to be displayed. The customer inputs, on the input screen, necessary information (name, transmission destination information, and the like) for membership registration. After the customer completes to input the necessary information, the electronic receipt management server 4 performs membership registration to the membership master. Then, the electronic receipt management server 4 delivers a membership registration completion mail including a member code (customer code) and a password to the portable terminal 7. As a result, the membership registration can be completed.

After the membership registration is performed in the above-described manner, the portable terminal 7 displays the member code of a customer as a reception destination code on a display unit 73 (see FIG. 6) thereof, by a code symbol such as a bar code and a two-dimensional code. The customer presents the code symbol displayed on the portable terminal 7, to a salesperson in the store P1 during a purchase transaction. The salesperson causes a code scanner 15 (see FIG. 2) which is connected to the POS terminal 1 to read the code symbol displayed on the portable terminal 7. As a result, a member code (reception destination code) of the customer may be correlated with electronic receipt information, which is generated in the POS terminal 1 through the merchandise sales data processing after settlement.

The portable terminal 7 receives electronic receipt information of the purchase transaction from the electronic receipt management server 4, through the network N5 after the settlement (transaction) in the POS terminal 1. An inquiry of electronic receipt information, which includes a designated member code, may be transmitted to the electronic receipt management server 4 through the network N5, and electronic receipt information of the member corresponding to the designated member code may be received from the electronic receipt management server 4, in response to the inquiry. The portable terminal 7 displays the received electronic receipt on the display unit 73.

In the electronic receipt system according to the present embodiment, electronic receipt information indicating details of a transaction (settlement), which is generated through the merchandise sales data processing executed by the POS terminal 1 of the store P1, is transmitted to the electronic receipt management server 4 through the electronic receipt server 3. The transmitted electronic receipt information is uploaded the web. By designating a uniform resource locator (URL) of a webpage on a web browser, the portable terminal 7 may download the electronic receipt information to the portable terminal 7 and display the downloaded receipt information using the web browser. Alternatively, an application for displaying electronic receipt information, different from the web browser, may be installed on the portable terminal 7.

Next, configurations of main apparatuses in the electronic receipt system according to the present embodiment will be described.

First, the POS terminal 1, which is the merchandise sales data processing apparatus, will be described. FIG. 2 is a block diagram of the POS terminal 1. As illustrated in FIG. 2, the POS terminal 1 includes a control unit 11 which generally controls various computations and each unit of the POS terminal 1. The control unit 11 includes a central processing unit (CPU), a read only memory (ROM), a random access memory (RAM), a real time clock (RTC) unit, and the like. The ROM stores various programs or data. The RAM stores various programs temporarily or stores various data in a rewritable manner. The RTC unit indicates the current date and time.

The control unit 11 is connected to an operation unit 12, the printer 13, a display unit 14, and the code scanner 15, through a bus 18.

The operation unit 12 has various operation keys in order for an operator to perform input operations. The operation keys include numeric keys for inputting numerical values, cursor keys, or a selection and determination key for selecting a predetermined item, a subtotal key for instructing to output a total price of merchandise subjected to sales registration, a settlement key for closing one transaction, a “calling an immediately preceding transaction” key for retrieving an immediately preceding transaction as a return target transaction”, and the like.

The printer 13 is a printer device for printing a receipt, a journal, or the like. The printer 13 includes a cutting mechanism (not illustrated) for cutting a paper sheet such as a roll paper, which is a printing target, and cuts off a paper sheet in accordance with a cut command.

The display unit 14 is, for example, a liquid crystal display, or the like, and displays various kinds of information including name and price of merchandise registered for sales, a total price, and an amount of change, in one transaction in which settlement is declared, and the like. The display unit 14 includes a display 14a for an operator which displays various kinds of information to a cashier and a display 14b for a customer which displays various kinds of information to a customer. The display unit 14 may have a touch panel. In this case, the touch panel functions as the operation unit 12.

The code scanner 15 is a scanner device which optically reads code symbols such as a barcode and a two-dimensional code. The code scanner 15 reads, for example, code symbols printed on merchandise, code symbols displayed on the portable terminal 7, and the like, and outputs information contained in the code symbol, to the control unit 11. A code symbol printed on merchandise contains a merchandise code of the merchandise, and the like. A code symbol displayed on the portable terminal 7 contains a member code (customer code) of a customer who carries the portable terminal 7.

The control unit 11 is connected to a communication I/F (interface) 16 through the bus 18, and configured to be connected to the network N1 or the network N2 in the store P1 through the communication I/F 16.

The control unit 11 is connected to a storage unit 17 through the bus 18. The storage unit 17 is an auxiliary storage device such as a hard disk drive (HDD) and a solid state drive (SSD), for example. The storage unit 17 stores a program for performing various POS operations including the merchandise sales data processing. The storage unit 17 stores various data files relating to the merchandise sales data processing, such as a merchandise data file. The merchandise data file stores merchandise data of merchandise, which includes a merchandise name, a merchandise code, a unit price, and the like of merchandise. The storage unit 17 stores a receipt information processing program 17a for executing the merchandise sales data processing or processing relating to electronic receipt information.

The storage unit 17 stores a POS number of the own POS terminal 1, a company code (identification code of a company which operates the store P1), a business type and business category code, a store code of the store P1 in which the POS terminal 1 is installed, and the like, in an identification code management region 17b. The business type and business category code is, for example, a code (classification code) for identifying a business type and a business category of a store, such as a convenience store, a supermarket, a department store, a pharmacy, a restaurant, an eatery, and the like. Such a business type and business category may be arbitrarily changed in accordance with preference of a user. The company code and the business type and business category code may be also registered in the electronic receipt server 3.

The storage unit 17 stores a receipt information schema 17c in which a conversion rule is defined, and which is used when receipt information of a non-structured format is converted into electronic receipt information of a structured format such as an XML and a CSV. Specifically, predetermined data elements of the receipt information, and attribute information (tag and the like) indicating the attributes of the predetermined data elements are defined in the receipt information schema 17c.

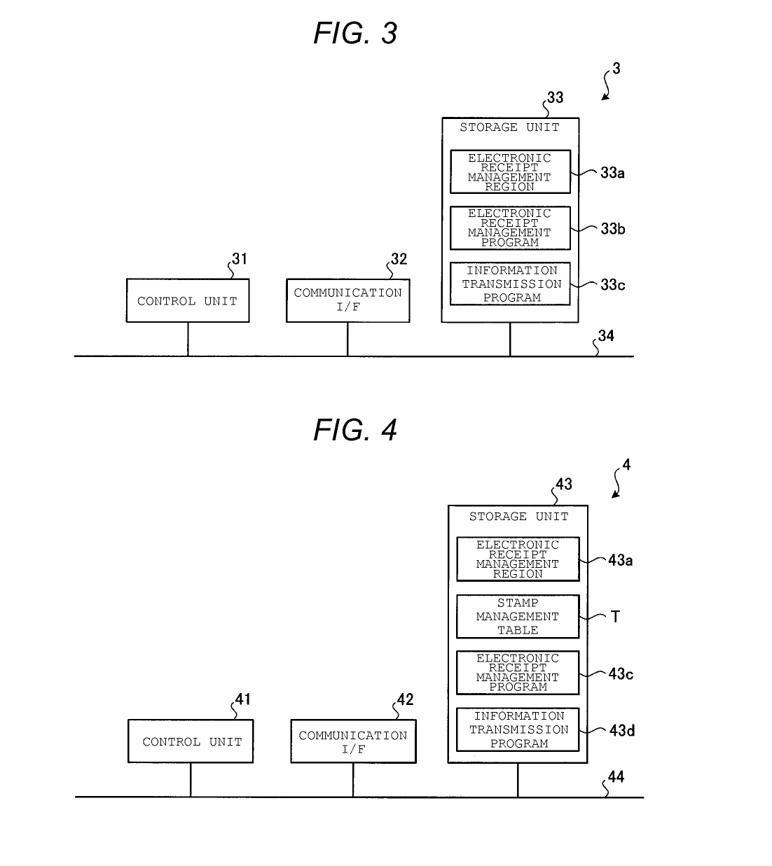

Next, a configuration of the electronic receipt server 3, which functions as the receipt management server for company, will be described with reference to a block diagram in FIG. 3. As illustrated in FIG. 3, the electronic receipt server 3 includes a control unit 31 which generally controls various computations and each unit of the electronic receipt server 3. The control unit 31 includes a CPU, a ROM, a RAM, an RTC unit, and the like. The ROM stores various programs or data. The RAM stores various programs temporarily or stores various data in a rewritable manner. The RTC unit indicates the current date and time.

The control unit 31 is configured to be connected to the network N2 or the network N3 through a communication I/F 32, which is connected to a bus 34. The control unit 31 is connected to a storage unit 33 through the bus 34.

The storage unit 33 stores electronic receipt information of a company, which operates one or more stores, in an electronic receipt management region 33a. The electronic receipt information includes a company code (identification code of a company which operates a store), a business type and business category code, a store code, a member code of a shopper, a POS number of the POS terminal 1, a receipt number, merchandise sales data, and the like.

The storage unit 33 stores an electronic receipt management program 33b for managing electronic receipt information stored in an electronic receipt management region 33a. The storage unit 33 also stores an information transmission program 33c for transmitting electronic receipt information stored in the electronic receipt management area 33a, to the electronic receipt management server 4.

Next, a configuration of the electronic receipt management server 4, which functions as the receipt management server for customer, will be described with reference to a block diagram in FIG. 4. As illustrated in FIG. 4, the electronic receipt management server 4 includes a control unit 41 which generally controls various computations and each unit of the electronic receipt management server 4. The control unit 41 includes a CPU, a ROM, a RAM, an RTC unit, and the like. The ROM stores various programs or data. The RAM stores various programs temporarily or stores various data in a rewritable manner. The RTC unit indicates the current date and time.

The control unit 41 is configured to be connected to the network N3, the network N4, and the network N5, through a communication I/F 42, which is connected to a bus 44. The control unit 41 is connected to a storage unit 43 through the bus 44.

The storage unit 43 has an electronic receipt management region 43a for collectively storing electronic receipt information of multiple companies each of which operate one or more stores, in addition to a membership master management region (not illustrated) for storing and managing the membership master. More specifically, the electronic receipt management region 43a is used to manage electronic receipt information of the multiple companies, with respect to each member (customer).

The electronic receipt information includes a member code, a company code (identification code of a company which operates a store), a store code, a POS number of the POS terminal 1, a transaction number, merchandise sales data (including date and time), and the like. For example, a manufacturer of consumer goods and the like may obtain a purchase proof of merchandise manufactured by the manufacturer from the electronic receipt information, in accordance with a specific condition (for example, a specific company (retailer), a specific geographic region, a specific time, and the like). The manufacturer of consumer goods may be a manufacturer of a food, a beverage, clothing, cosmetics, a medicine, household goods, and the like.

The storage unit 43 stores an electronic receipt management program 43c for managing electronic receipt information of the multiple companies stored in the electronic receipt management region 43a, in addition to a membership management program (not illustrated) for managing the membership master in a membership master region. The storage unit 43 also stores an information transmission program 43d for transmitting electronic receipt information to the portable terminal 7. The membership master management region and the electronic receipt management region 43a correspond to the database DB illustrated in FIG. 1.

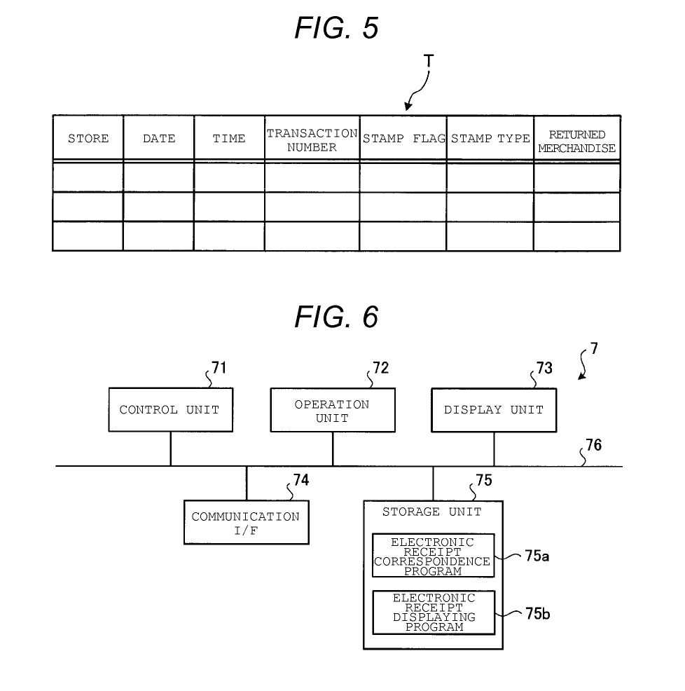

The storage unit 43 stores a stamp management table T. FIG. 5 illustrates an example of a data structure of the stamp management table T. As illustrated in FIG. 5, the stamp management table T contains stamp information (stamp flag, stamp type (stamp ID), merchandise to be returned (merchandise code), and the like) in association with information (store, date, time, and transaction number) that can identify a receipt that is subjected to specific processing (for example, stamp processing). The stamp information indicates execution of the stamp processing. That is, the stamp management table T functions as a stamp information management section. The stamp information may include a stamp image.

In the present embodiment, “return” will be described as an example of a stamp type of the stamp information. The “return” is a stamp type indicating that the POS terminal 1 has executed the return processing.

The electronic receipt management program 43c and the information transmission program 43d, which are executed by the electronic receipt management server 4 according to the present embodiment, are files of an installable format or an executable format. The programs 43c and 43d are stored in a computer readable recording medium such as a CD-ROM, a flexible disk (FD), a CD-R, and a digital versatile disk (DVD).

Alternatively, the electronic receipt management program 43c and the information transmission program 43d may be stored in a computer which is connected to a network such as the Internet, and provided by being downloaded through a network. The electronic receipt management program 43c and the information transmission program 43d further may be provided or distributed through a network such as the Internet.

Further, the electronic receipt management program 43c and the information transmission program 43d may be configured so as to be stored in the ROM and the like in advance.

Next, a configuration of the portable terminal 7 will be described with reference to a block diagram in FIG. 6. As illustrated in FIG. 6, the portable terminal 7 includes a control unit 71 which generally controls various computations and each unit of the portable terminal 7. The control unit 71 includes a CPU, a ROM, a RAM, an RTC unit, and the like. The ROM stores various programs or data. The RAM stores various programs temporarily or stores various data in a rewritable manner. The RTC unit indicates the current date and time.

The control unit 71 is connected to an operation unit 72 and a display unit 73 through a bus 76. The operation unit 72 has various operation keys or a pointing device in order for a user (customer) to perform input operations. The display unit 73 is, for example, a liquid crystal display, and displays various kinds of information including the electronic receipt information. The display unit 73 may have a touch panel. In this case, the touch panel functions as the operation unit 72.

The control unit 71 is connected to a communication I/F 74 through a bus 76, and is configured to be connected to the network N5 through the communication I/F 74. The control unit 71 is also configured to be connected to the network N1 in the store P1 through the communication I/F 74.

The control unit 71 is connected to a storage unit 75 through the bus 76. The storage unit 75 stores an electronic receipt correspondence program 75a for receiving electronic receipt information from the electronic receipt management server 4, and an electronic receipt displaying program 75b for displaying the received electronic receipt information, in addition to a web browser for displaying various kinds of information (contents) uploaded on a web.

Next, an operation of each apparatus in the electronic receipt system according to the present embodiment will be described.

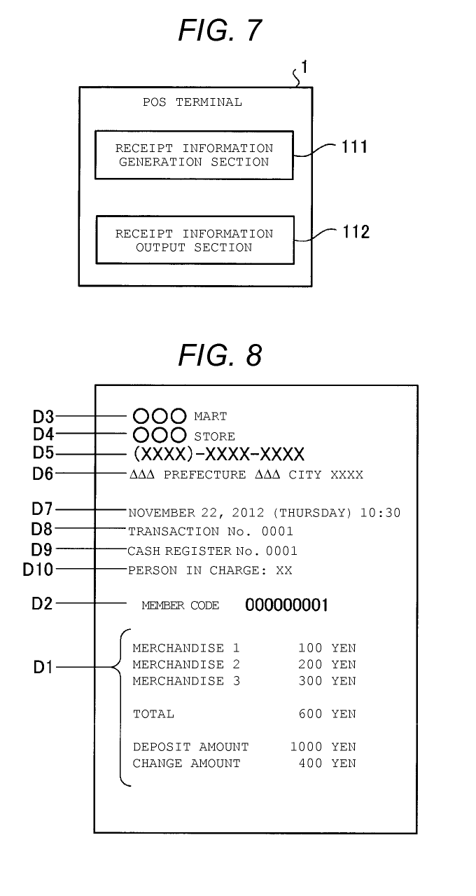

First, electronic receipt processing carried out when the control unit 11 of the POS terminal 1 executes the receipt information processing program 17a will be described with reference to FIGS. 7 to 10.

As illustrated in FIG. 7, when the receipt information processing program 17a is executed by the POS terminal 1, modules including a receipt information generation section 111 and a receipt information output section 112 are generated. As actual hardware, the CPU of the control unit 11 reads the receipt information processing program 17a from the storage unit 17 and executes the read receipt information processing program 17a. As a result, each section is loaded on the RAM, and the receipt information generation section 111 and the receipt information output section 112 are generated on the RAM.

The receipt information generation section 111 mainly executes the merchandise sales data processing and generates print data (receipt information) of a receipt. The receipt information generation section 111 is a functional unit corresponding to an existing application. If a merchandise code of merchandise is obtained through the code scanner 15, the receipt information generation section 111 reads merchandise data corresponding to the obtained merchandise code from a merchandise data file and executes the merchandise sales data processing to calculate a total price based on a unit price, which is included in the read merchandise data. The receipt information generation section 111 generates merchandise sales data through the merchandise sales data processing, that is, receipt information including details of the purchase transaction.

The merchandise sales data processing includes the return processing of returned purchased merchandise. The code scanner 15 connected to the POS terminal 1 reads a code symbol (member code) displayed on the portable terminal 7 and a merchandise code of merchandise to be returned. Then, the return processing in the POS terminal 1 is executed with respect to the merchandise corresponding to the read merchandise code. When a return target transaction of the return processing is an immediately preceding transaction, data of an immediately preceding transaction may be retrieved by operating the “calling an immediately preceding transaction” key (not illustrated) provided in the operation unit 12. A code symbol representing the return target transaction displayed on the portable terminal 7 may be read by the code scanner 15, and data of the target transaction may be searched and retrieved from a journal file of the store server 2 using the read code symbol.

If a member code of a customer is obtained through the code scanner 15 at any timing in one transaction, the receipt information generation section 111 includes the obtained member code in the receipt information.

FIG. 8 illustrates an example of an image of receipt information. The receipt information is text data and the like in the non-structured format, and is used in printing by the printer 13. As illustrated in FIG. 8, the receipt information includes merchandise sales data D1 and member code D2. The merchandise sales data D1 includes a merchandise name (merchandise code) of purchased merchandise, and a price of the merchandise, a total price of all purchased merchandise, a deposit amount which is paid by a customer, a change amount, and the like.

The receipt information also includes a company code (company name) D3 of a company which operates a store, a store code (store name) D4, a telephone number D5 of the store, an address D6, transaction date and time D7, a transaction number (receipt number) D8, a cash register number D9, a name of a person in charge D10, and the like. The data elements included in the receipt information are not limited to an example in FIG. 8, and may include other data elements such as a business type and business category code, or may exclude data elements, for example, the telephone number D5, the address D6, or the like.

When the return processing is executed, a specific character indicating execution of the return processing is included in the receipt information in correlation with the returned merchandise (merchandise code).

If pressing of the settlement key is recognized, the receipt information generation section 111 determines that the merchandise sales data processing for one transaction is completed, outputs (issues) the generated receipt information and a cut command to the receipt information output section 112. The cut command is one of generally-used printer control commands, and instructs to cut a paper sheet on which receipt information is printed. The receipt information may be collectively generated in accordance with pressing of the settlement key, or may be sequentially generated every time the merchandise code or the customer code is obtained.

The receipt information output section 112 determines an output destination of receipt information every time the receipt information generation section 111 generates the receipt information of one transaction. More detailedly, if the receipt information generation section 111 issues the cut command, the receipt information output section 112 determines that receipt information of one transaction is generated. The receipt information output section 112 determines whether or not the member code is included in the generated receipt information, and outputs the receipt information to an output destination in accordance with a determination result.

Specifically, when it is determined that the member code is not included in the receipt information, the receipt information output section 112 outputs the receipt information along with the cut command to the printer 13. Then, the printer 13 prints the receipt information on a paper sheet and cuts the paper sheet in accordance with the cut command. As a result, the printer 13 prints out a paper receipt of one transaction. When printing and outputting are performed, all data elements of the receipt information may be printed. Alternatively, the member code or the like may be excluded or another data element such as an advertisement may be added.

When it is determined that the member code is included in the receipt information, the receipt information output section 112 converts a data format of the receipt information into a predetermined data format in accordance with the conversion rule defined in the receipt information schema 17c. The receipt information output section 112 transmits (outputs) receipt information obtained by converting a data format, that is, electronic receipt information, to the electronic receipt server 3 which manages the electronic receipt information of the corresponding company.

The receipt information output section 112 detects the specific character, which indicates execution of the return processing and is correlated with the returned merchandise (merchandise code). When digitalization of receipt information is performed, the receipt information output section 112 adds receipt attribute information indicating the execution of the return processing to the receipt information, and transmits the receipt information including the receipt attribute information to the electronic receipt server 3.

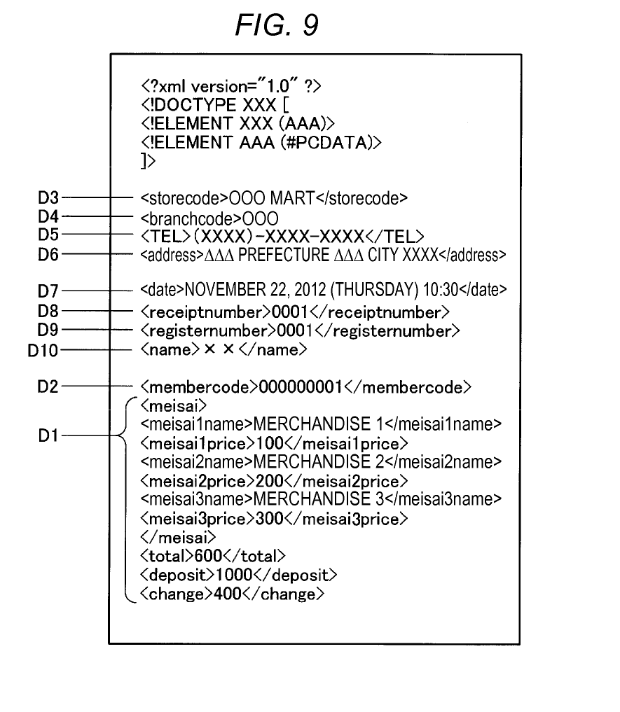

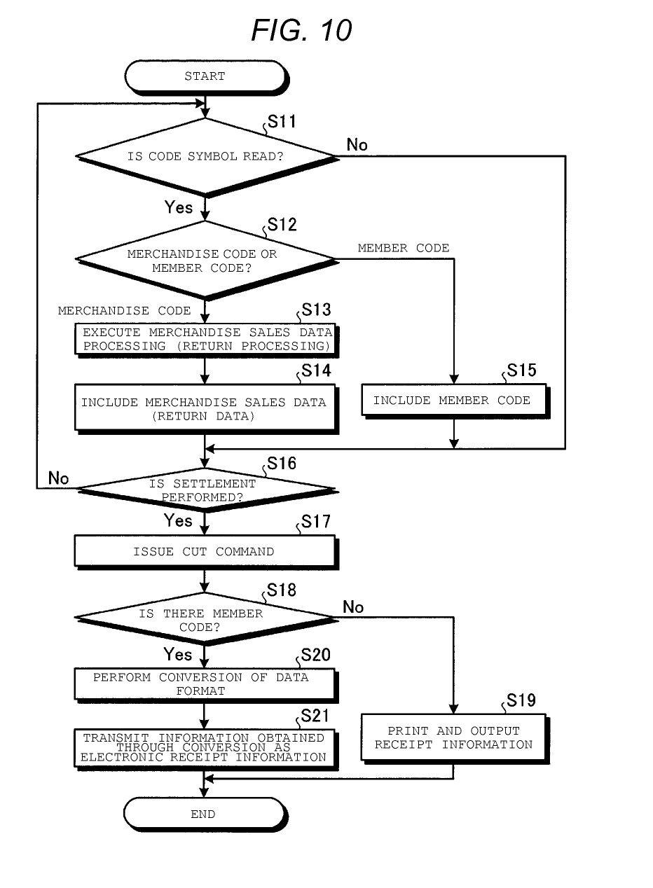

FIG. 9 illustrates an example of the electronic receipt information. As illustrated in FIG. 9, the electronic receipt information includes data (structured document) of the structured format such as an XML and a CSV. In FIG. 9, data format of each data element (D1 to D10) of the receipt information illustrated in FIG. 8 is converted to an XML format.

Receipt information is converted into electronic receipt information based on the conversion rule defined in the receipt information schema 17c. Specifically, a predetermined data element of the receipt information and attribute information (tag and the like) indicating an attribute of the data element are defined in the receipt information schema 17c. The receipt information output section 112 generates electronic receipt information of the structured format illustrated in FIG. 9 by structuring each data element of the receipt information based on the attribute information corresponding to each data element. As a result, by generating the electronic receipt information of the structured format in this manner, it is possible to efficiently use data elements included in the electronic receipt information, and obtain various advantages in data management.

As described above, the receipt information output section 112 determines that receipt information of one transaction is generated based on the cut command issued by the receipt information generation section 111, and then starts to output the receipt information. As the receipt information output section 112 does not need a dedicated signal to recognize the completion of one transaction from the receipt information generation section 111, a the receipt information generation section 111 corresponding to an existing application may be used without modification.

The receipt information output section 112 determines an output destination of the receipt information in accordance with whether or not the member code is included in the receipt information. Since a paper receipt or electronic receipt information may be output without dedicated information indicating whether or not a paper receipt is requested, it is possible to efficiently determine an output destination of the receipt information. For example, a customer (member) can select the output destination of the receipt information based on inputs or non-inputs of a member code. As a result, it is possible to improve customer convenience.

When the receipt information is output to the electronic receipt server 3, the receipt information output section 112 converts data elements of the receipt information into electronic receipt information of a structured format and outputs the electronic receipt information. As a result, the data elements of the electronic receipt information may be efficiently used by the electronic receipt server 3 and the electronic receipt management server 4 which manage the electronic receipt information, or by the portable terminal 7 which displays the electronic receipt information.

FIG. 10 is a flowchart illustrating a flow of electronic receipt processing carried out by the POS terminal 1. First, the receipt information generation section 111 of the POS terminal 1 determines whether or not the code scanner 15 reads a code symbol (merchandise code) printed on merchandise or a code symbol (member code) displayed on the portable terminal 7 (Step S11). When the code symbol is not read (No in Step S11), the process proceeds to Step S16.

When the code symbol is determined to be read (Yes in Step S11), the receipt information generation section 111 determines whether information obtained by reading of the code scanner 15 is a merchandise code or a member code (Step S12).

In Step S12, when a merchandise code is obtained (merchandise code in Step S12), merchandise data of merchandise specified by the merchandise code is read from the merchandise data file, and the receipt information generation section 111 executes the merchandise sales data processing to calculate a price based on a unit price included in the merchandise data (Step S13). At this step, when a return mode is set in advance, the receipt information generation section 111 also executes the return processing. The receipt information generation section 111 generates receipt information including merchandise sales data through the merchandise sales data processing or return data processed through the return processing (Step S14).

When the member code is obtained in Step S12 (member code in Step S12), the receipt information generation section 111 includes the member code in the receipt information (Step S15).

In order to input the member code to the POS terminal 1, for example, a customer (member) presents a code symbol representing the member code and the like displayed on the display unit 73 of the portable terminal 7, and then a salesperson or the customer itself scans the code symbol using the code scanner 15 of the POS terminal 1. The receipt information generation section 111 may execute exclusion processing or the like such that only one member code is associated with the purchase transaction when two or more member codes are input.

Sequentially, in Step S16, the receipt information generation section 111 determines whether or not the settlement processing is instructed by pressing of the settlement key and the like (Step S16). When the settlement processing is not instructed (No in Step S16), the process returns to Step S11. When the settlement processing is instructed (Yes in Step S16), the receipt information generation section 111 issues (outputs) the cut command to the receipt information output section 112 (Step S17).

If the cut command is received from the receipt information generation section 111, the receipt information output section 112 determines that receipt information of one transaction is generated, and determines whether or not the generated receipt information includes a member code (Step S18).

When the receipt information does not include the member code (No in Step S18), the receipt information output section 112 outputs the receipt information of the transaction and the cut command to the printer 13 for printing the receipt information as a paper receipt (Step S19). Then, the printer 13 prints out the paper receipt of the transaction on a paper sheet, and then cuts the paper sheet in accordance with the cut command.

When the receipt information includes the member code (Yes in Step S18), the receipt information output section 112 generates electronic receipt information by converting a data format of the receipt information, which is the non-structured format, into the structured format, based on the conversion rule defined in the receipt information schema 17c (Step S20). The receipt information output section 112 transmits the generated electronic receipt information to the electronic receipt server 3 through the communication I/F 16 (Step S21), and then the processing is ended.

In the above processing, when the receipt information includes the member code, the receipt information is output to the electronic receipt server 3; however, the processing is not limited thereto. For example, the receipt information may be output to both the printer 13 and the electronic receipt server 3.

Alternatively, when the receipt information includes the member code, an output destination of the receipt information may be selectable. For example, the portable terminal 7 may include output classification information designating an output destination of the receipt information in a code symbol to be displayed, and instruct the output destination based on the output classification information. In this case, the receipt information generation section 111 includes the output classification information read by the code scanner 15 in the receipt information along with a member code. When the receipt information output section 112 determines that the receipt information includes the member code and the output classification information, the receipt information output section 112 sets an output destination of the receipt information based on the output classification information. Here, either one or both of the printer 13 and the electronic receipt server 3 may be designated and included in the output classification information.

An output destination of the receipt information may be selected every time the purchase transaction is performed. In this case, for example, when it is determined that the receipt information includes the member code, the receipt information output section 112 displays an output destination selection screen for selecting an output destination of the receipt information on the display unit 14.

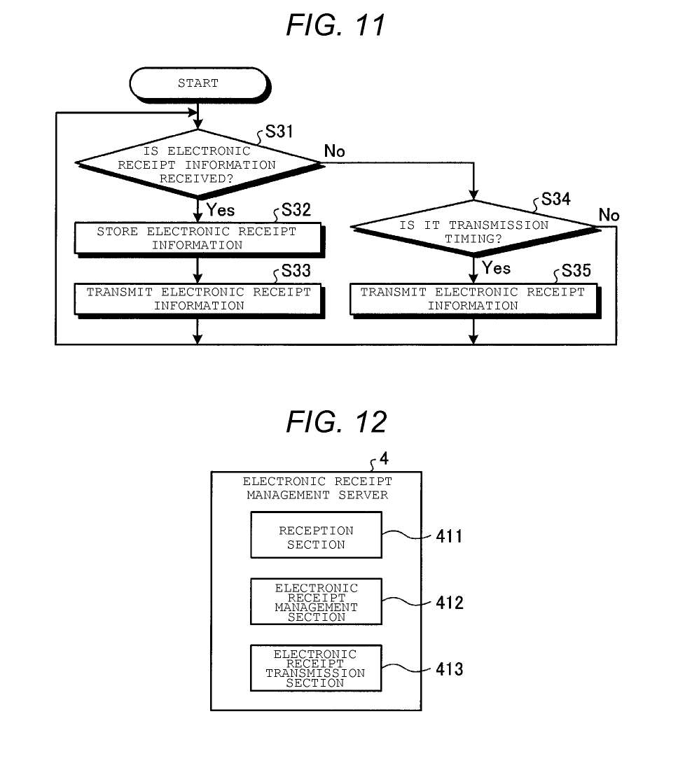

Next, a flow of electronic receipt management processing and information transmission processing will be described with reference to a flowchart illustrated in FIG. 11. The electronic receipt management processing is executed when the control unit 31 of the electronic receipt server 3 executes the electronic receipt management program 33b. The information transmission processing is executed when the control unit 31 of the electronic receipt server 3 executes the information transmission program 33c.

If electronic receipt information transmitted from the POS terminal 1 is received through the communication I/F 32 (Yes in Step S31), the control unit 31 of the electronic receipt server 3 stores the received electronic receipt information in the electronic receipt management region 33a of the storage unit 33 (Step S32). The control unit 31 of the electronic receipt server 3 transmits the electronic receipt information which is stored in Step S32, to the electronic receipt management server 4 (Step S33). Then, the process returns to Step S31.

If a transmission timing which is set in advance comes (No in Step S31 and Yes in Step S34), the control unit 31 of the electronic receipt server 3 transmits the electronic receipt information stored in the electronic receipt management region 33a, to the electronic receipt management server 4 (Step S35), and then the process returns to Step S31. According to Step 35, it is possible to transmit electronic receipt information that has not been successfully transmitted in Step S33, for example, to the electronic receipt management server 4. In Step S35, only electronic receipt information that has not been successfully transmitted in Step 33 may be transmitted.

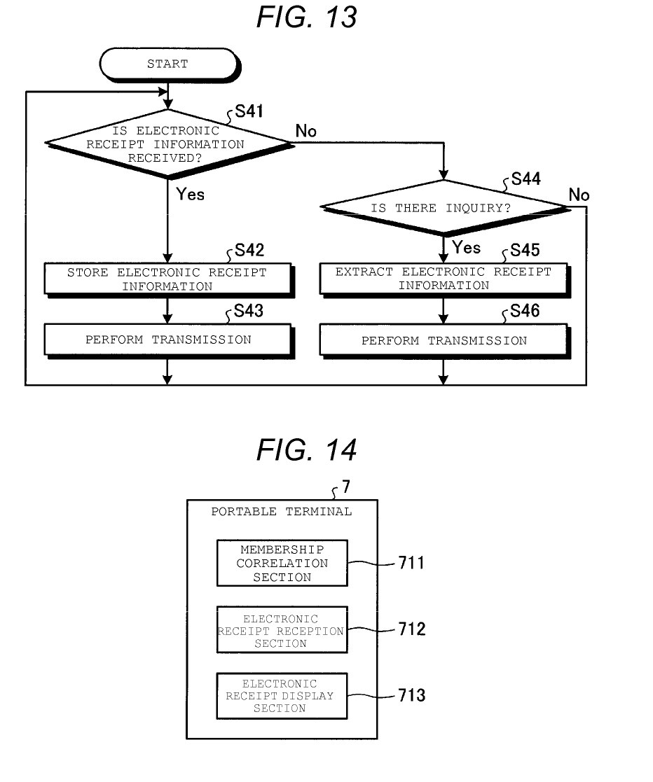

Next, a flow of electronic receipt management processing and merchandise information transmission processing will be described with reference to a block diagram illustrated in FIG. 12 and a flowchart illustrated in FIG. 13. The electronic receipt management processing is executed when the control unit 41 of the electronic receipt management server 4 executes the electronic receipt management program 43c. The merchandise information transmission processing is executed when the control unit 41 executes the information transmission program 43d.

As illustrated in FIG. 12, when the electronic receipt management program 43c and the information transmission program 43d are executed by the electronic receipt management server 4, modules including a reception section 411, an electronic receipt management section 412, and an electronic receipt transmission section 413 are generated. As actual hardware, the CPU of the control unit 41 reads and executes the electronic receipt management program 43c and the information transmission program 43d from the storage unit 43. As a result, each section is loaded on the RAM, and the reception section 411, the electronic receipt management section 412, and the electronic receipt transmission section 413 are generated on the RAM.

The reception section 411 receives electronic receipt information of each company, which is electronically processed instead of the receipt printed and issued, from the electronic receipt server 3 after the merchandise sales data processing has been performed. The receipt or the electronic receipt information includes a company code of a corresponding company.

The electronic receipt management section 412 stores and manages electronic receipt information of each company which is received by the reception section 411 and stored in the electronic receipt management region 43a of the storage unit 43.

When a specific character indicating execution of the return processing is included in the electronic receipt information of each company which is received by the reception section 411, the electronic receipt management section 412 stores and manages the electronic receipt information as return electronic receipt information in the stamp management table T of the storage unit 43. More specifically, if the return electronic receipt information including a specific character which indicates execution of the return processing and is correlated with returned merchandise (merchandise code) is received, the electronic receipt management section 412 stores information (store, date, time, transaction number, and returned merchandise (merchandise code)) specifying a receipt for which the return processing of merchandise is executed, in the stamp management table T, validates a stamp flag in the stamp management table T, and sets a stamp type to be “return” in the stamp management table T.

The electronic receipt transmission section 413 functions as a section to enable display of an electronic receipt. The electronic receipt transmission section 413 obtains electronic receipt information which is correlated with a predetermined member code and includes one or more of company codes, from the electronic receipt management region 43a, and transmits the obtained electronic receipt information to the portable terminal 7 correlated with the predetermined member code, and enables the transmitted electronic receipt information to be displayed. When stamp information (stamp flag, stamp type, returned merchandise (merchandise code), and the like) stored in the stamp management table T is correlated with the electronic receipt information, the electronic receipt transmission section 413 obtains the stamp information from the stamp management table T, and transmits the obtained stamp information along with the electronic receipt information, so that the transmitted information can be displayed.

As illustrated in FIG. 13, the reception section 411 of the electronic receipt management server 4 determines whether or not electronic receipt information transmitted from the electronic receipt server 3 of each company is received through the communication I/F 42 (Step S41).

When the electronic receipt information is received (Yes in Step S41), if the electronic receipt information is general electronic receipt information, the electronic receipt management section 412 of the electronic receipt management server 4 stores the electronic receipt information in the electronic receipt management region 43a of the storage unit 43. If the electronic receipt information is electronic receipt information (return electronic receipt information) relating to the return processing, the electronic receipt management section 412 stores information specifying receipts related to the return processing and the stamp information in the stamp management table T of the storage unit 43 (Step S42).

Sequentially, when the electronic receipt information is stored in Step S42, the electronic receipt transmission section 413 transmits the stored electronic receipt information to a transmission destination (portable terminal 7) which is correlated with a member code of the electronic receipt information. When the return electronic receipt information is stored in Step S42, the electronic receipt transmission section 413 transmits the stored stamp information and electronic receipt information correlated with the return electronic receipt information, to the transmission destination (Step S43). Then, the process returns to Step S41.

When an inquiry of electronic receipt information is received from the portable terminal 7 (No in Step S41 and Yes in Step S44), the electronic receipt transmission section 413 of the electronic receipt management server 4 extracts electronic receipt information stored in the electronic receipt management region 43a, and stamp information correlated with identification information (store, date, time, and transaction number) of the electronic receipt information, in response to the inquiry of the electronic receipt information (Step S45). Then, the electronic receipt transmission section 413 transmits the extracted electronic receipt information and the stamp information to the portable terminal 7 which has transmitted the inquiry (Step S46), and then the process returns to Step S41.

Next, a flow of electronic receipt reception processing and electronic receipt displaying processing will be described with reference to FIGS. 14 to 16. The electronic receipt reception processing is executed when the control unit 71 of the portable terminal 7 executes the electronic receipt correspondence program 75a. The electronic receipt displaying processing is executed, when the control unit 71 executes the electronic receipt displaying program 75b.

As illustrated in FIG. 14, when the electronic receipt correspondence program 75a and the electronic receipt displaying program 75b are executed by the portable terminal 7, modules including a membership correlation section 711, an electronic receipt reception section 712, and an electronic receipt display section 713 are generated. As actual hardware, the CPU of the control unit 71 reads and executes the electronic receipt correspondence program 75a and the electronic receipt displaying program 75b from the storage unit 75. As a result, each section is loaded on the RAM, and the membership correlation section 711, the electronic receipt reception section 712, and the electronic receipt display section 713 are generated on the RAM.

The membership correlation section 711 correlates a predetermined member code of a shopper with the portable terminal 7. The electronic receipt reception section 712 receives electronic receipt information and stamp information from the electronic receipt management server 4. The electronic receipt display section 713 operates to display the electronic receipt information and the stamp information received by the electronic receipt reception section 712, on the display unit 73.

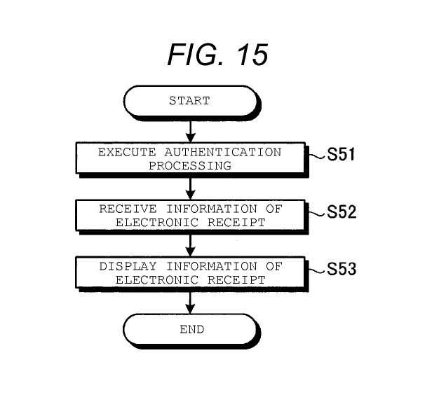

As illustrated in FIG. 15, first, the membership correlation section 711 of the portable terminal 7 accesses the electronic receipt management server 4, and executes authentication processing by inputting a member code and a password (Step S51). Through Step S51, the portable terminal 7 and the predetermined member code of a shopper are correlated with each other.

After the authentication, the electronic receipt reception section 712 of the portable terminal 7 receives electronic receipt information and stamp information stored in the electronic receipt management region 43a of the electronic receipt management server 4 in association with the input member code (Step S52). Here, the electronic receipt information may be received through an e-mail.

Then, the electronic receipt display section 713 of the portable terminal 7 operates to display the electronic receipt information and the stamp information received by the electronic receipt reception section 712, on the display unit 73 (Step S53), and the processing is ended.

More specifically, when an electronic receipt image to be displayed on the portable terminal 7 of a consumer is generated, if a stamp flag of stamp information correlated with identification information (store, date, time, and transaction number) of the electronic receipt information is “valid”, and a stamp type is “return”, the electronic receipt display section 713 of the portable terminal 7 integrates a stamp (for example, “strikethrough” and “return mark”) and returned merchandise of the electronic receipt information, and operates to display a result of the integration. That is, since the return processing on the electronic receipt information is executed by integrating data in the stamp management table T and the electronic receipt information, the electronic receipt information stored in the electronic receipt management region 43a maintains an original state as it is.

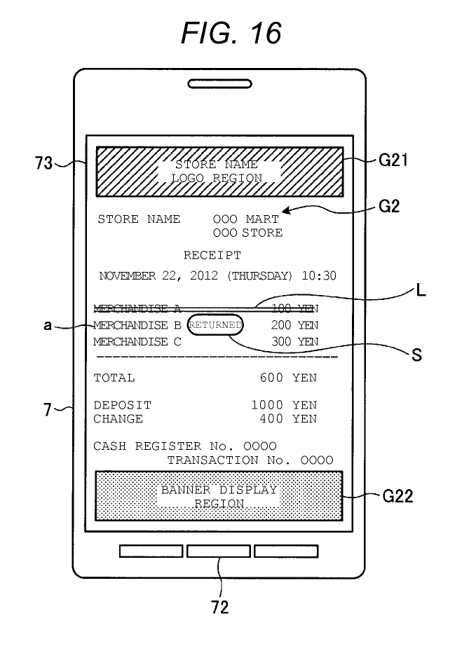

FIG. 16 illustrates an example of return electronic receipt information G2 displayed on the display unit 73 of the portable terminal 7. The return electronic receipt information G2 has a similar layout or similar details to a paper receipt. On the display unit 73, purchased merchandise a, may be selected using a cursor following an input on the operation unit 72. In FIG. 16, the return electronic receipt information G2 includes, for example, a store name logo region G21 for displaying a logo of a store name, a banner display region G22 for displaying an advertisement, and the like.

As illustrated in FIG. 16, a stamp (for example, “strikethrough” L and “return mark” S) which is defined to indicate “return” of merchandise is integrated with the returned merchandise, and a result of the integration is displayed as an image.

In the present embodiment, a display state of the electronic receipt information may not be the same as an image of a paper receipt. However, the electronic receipt information can be a substitute of the paper receipt and thus a proof of the purchase transaction. In FIG. 16, the electronic receipt information, which can be used as the proof of the purchase transaction, includes the following information.
Store name
Date and time of a purchase
Description of purchased merchandise
Total price of purchased merchandise
Deposit amount
Change amount
Cash register number
Transaction number

In the present embodiment, when multiple pieces of electronic receipt information are received, the display unit 73 may display a selection screen to select one piece of electronic receipt information based on a purchase date, a company code, or the like included in the electronic receipt information. In this case, the electronic receipt display section 713 operates to display electronic receipt information selected through the selection screen, on the display unit 73.

As described above, according to the electronic receipt management server of the present embodiment, when the received electronic receipt information is information subjected to the stamp processing, stamp information indicating execution of the stamp processing is stored in association with identification information of electronic receipt information for which the stamp processing has been executed. When the stamp information is correlated with electronic receipt information to be transmitted, the stamp information is transmitted to the portable terminal 7 along with the electronic receipt information. As a result, it is possible to enable mark stamping on an electronic receipt without modifying the original electronic receipt information. Further, even if processing of an electronic signature, a time stamp, or the like is performed on the electronic receipt information in order to improve security of data, the original electronic receipt information will not be falsified by the mark stamping.

In the present embodiment, “return”, which is a type indicating execution of the return processing by the POS terminal 1, is used as an example of a stamp type indicating that the stamp processing has been executed. However, the stamp type is not limited thereto. Other stamp types are described as follows.

Provision of an incentive (exchange for a giveaway, issue of a parking validation stub, and the like)

For example, the stamp type may be a stamp for a receipt for which a promotional gift has been given or a stamp for a receipt for which a parking validation stub has been issued. For example, the operation unit 12 of the POS terminal 1 may have a stamp key (key for offering a promotional gift or key for issuing a parking validation stub) for electronic receipt information, and operation of the stamp key indicates that stamping has been performed. When the stamp key (key of a giveaway exchange or key of a parking stub issue) is pressed, the receipt information generation section 111 of the POS terminal 1 includes a specific character indicating that a promotional gift has been offered or that a parking validation stub has been issued in receipt information as one element of receipt attribute information.

When the specific character is detected and digitalization is performed, the receipt information output section 112 of the POS terminal 1 adds sealing for the promotional gift offer or the parking stub issuance as one of receipt attribute information, and transmits a result of addition to the electronic receipt server 3.

Then, if electronic receipt information including the specific character indicating the offer of the promotional gift or issue of a parking validation stub is received, the electronic receipt management section 412 of the electronic receipt management server 4 stores information (store, date, time, and transaction number) that specifies a receipt for which the offer of the promotional gift or the issue of the parking validation stub has been performed, in the stamp management table T, validates a stamp flag in the stamp management table T, and sets a stamp type in the stamp management table T to be “offer of a promotional gift” or “issue of a parking validation stub”.

When electronic receipt information is displayed on the portable terminal 7, if the stamp flag is valid and the stamp type is “offer of a promotional gift” or “issue of a parking validation stub”, an offer completion stamp or an issue completion stamp which are set for “offer of a promotional gift” or “issue of a parking validation stub,” and the electronic receipt information are integrated.

Point Mark Stamping

The stamp type may also be a point mark (stamp). For example, the operation unit 12 of the POS terminal 1 may have a stamp key (point provision key) that instructs provision of reward points in association with electronic receipt information. When the stamp key (point provision key) is operated, the receipt information generation section 111 of the POS terminal 1 includes a specific character indicating provision of the point stamp in receipt information as one element of receipt attribute information. A condition to determine whether or not the reward point is provided may be set in the POS terminal 1.

When the specific character is detected and digitalization is performed, the receipt information output section 112 of the POS terminal 1 adds a point stamp as the receipt attribute information, and transmits a result of the addition to the electronic receipt server 3.

Then, if electronic receipt information including the specific character indicating provision of the point stamp is received, the electronic receipt management section 412 of the electronic receipt management server 4 stores information (store, date, time, and transaction number) specifying a receipt for which the point stamp has been provided, in the stamp management table T, validates a stamp flag in the stamp management table T, and sets a stamp type in the stamp management table T to be “point stamp”.

As a result, when electronic receipt information is displayed on the portable terminal 7, if the stamp flag is valid and the stamp type is “point stamp”, a point stamp which is defined for “point stamp” in advance, and the electronic receipt information are integrated. In a case of managing a defined amount of money, the number of stages may be displayed.

The above descriptions are made on an assumption that a defined stamp is added to electronic receipt information. However, design of the stamp may be different among companies which participate in the electronic receipt system. When a device of a digital pen or the like is connected to the POS terminal 1, a handwritten digital signature may be added to electronic receipt information.

### Second Embodiment

A second embodiment will be described hereinafter. The same components as those in the first embodiment are depicted using the same reference numerals and description thereof will be omitted.

An immediately preceding transaction is read as a return target transaction in the first embodiment. In contrast, in the second embodiment, a target transaction is searched for and read from a journal file in the store server 2.

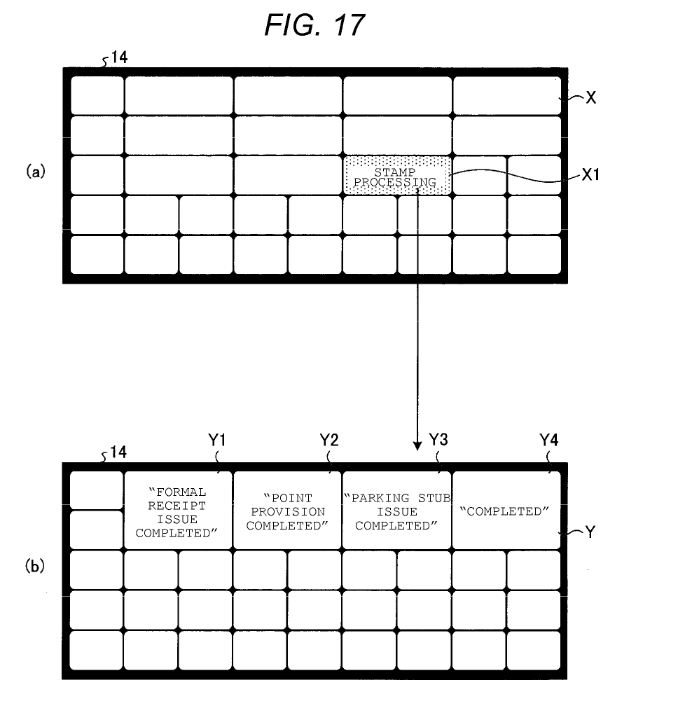

FIG. 17 illustrates screen transition of screens relating the stamp processing in an electronic receipt system according to the second embodiment. First, the control unit 11 of the POS terminal 1 performs a journal file search operation by searching for an original receipt, which is a search target, from a journal file stored in the store server 2.

Next, the control unit 11 of the POS terminal 1 operates to display an operation selection screen X ((a) of FIG. 17) including a list of various operations on the display unit 14. When it is determined that a “stamp processing” button X1 is pressed on the operation selection screen X ((a) of FIG. 17) displayed on the display unit 14, the control unit 11 of the POS terminal 1 starts the stamp processing.

When it is determined that the “stamp processing button X1 is pressed on the operation selection screen X, the control unit 11 of the POS terminal 1 operates to display a stamp selection screen Y ((b) of FIG. 17) on the display unit 14. “Stamp” buttons Y1 to Y4, which are selectable on the stamp selection screen Y ((b) of FIG. 17), include the followings, for example.
“formal receipt issue completed”
“point provision completed”
“parking stub issue completed”
“completed”

The “formal receipt issue completed” button Y1 is used to display a mark indicating that a formal receipt, which is different from the paper receipt, has been issued, and the mark corresponds to a stamp put on the paper receipt in a conventional practice. The “point provision completed” button Y2 is used to display a mark indicating that the receipt is eligible to receive reward points after a purchase transaction when a dedicated point card was not presented during the purchase transaction, and the mark corresponds to a stamp put on a paper receipt in a conventional practice. The “parking stub issue completed” button Y3 is used to display a mark indicating that a parking validation stub has been given in a store where a parking validation stub for N hours is provided for purchase of XX yen or more, and the mark corresponds to a stamp put on a paper receipt in a conventional practice. The “completed” button Y4 may be used for multiple purposes. For example, the “completed” button Y4 is used to display a mark indicating that a reward stamp has been given, in a store where the reward stamp is given for each purchase of XX yen.

If it is determined that any one of the “stamp” buttons Y1 to Y4 is pressed on the stamp selection screen Y ((b) of FIG. 17) displayed on the display unit 14, the control unit 11 of the POS terminal 1 starts the stamp processing.

In the stamp processing, the control unit 11 of the POS terminal 1 creates receipt information, which is dummy printing data, based on a member code, a company ID, a store code, a point card number, a stamp character string of the selected stamp, and the like in addition to an original POS number, an original receipt number (transaction number) of an original receipt, and date and time of the original transaction.

Since a member code is included in receipt information, the control unit 11 (receipt information output section 112) of the POS terminal 1 generates stamp information by converting a data format of the receipt information, which is the non-structured format, into the structured format based on the conversion rule defined in the receipt information schema 17c. The control unit 11 transmits the generated stamp information to the electronic receipt server 3.

The stamp information is stored in the electronic receipt management region 43a of the electronic receipt management server 4 through the electronic receipt server 3.

When there is an access from the portable terminal 7, the electronic receipt management server 4 transmits the electronic receipt information and the stamp information to the portable terminal 7, and the electronic receipt information and the stamp information are displayed on the display unit 73 of the portable terminal 7.

More specifically, when an electronic receipt image to be displayed on the portable terminal 7 is generated, if there is stamp information correlated with identification information (store, date, time, and transaction number) of the electronic receipt information transmitted from the portable terminal 7, the electronic receipt management server 4 generates a stamp image in accordance with the stamp character string (for example, “formal receipt issue completed”, “point provision completed”, “parking stub issue completed”, “completed”, and the like) of the selected stamp. Then, the electronic receipt management server 4 incorporates the stamp image into the image of the electronic receipt information. The electronic receipt information and the stamp image integrated in this manner are displayed on the display unit 73 of the portable terminal 7.

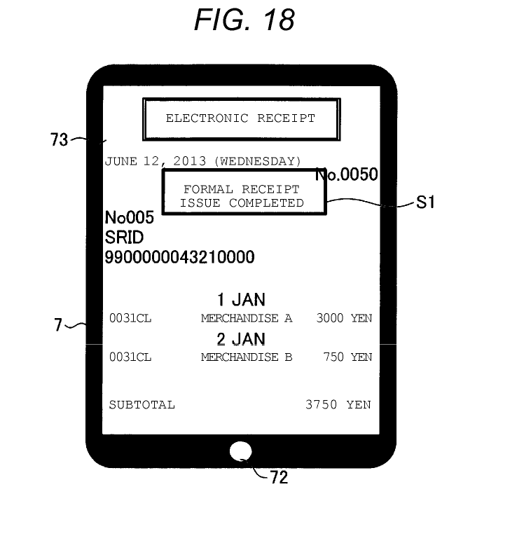

FIG. 18 illustrates an example of an electronic receipt image G3 displayed on the display unit 73 of the portable terminal 7. The electronic receipt image G3 has a similar layout or similar elements to a paper receipt. As illustrated in FIG. 18, when any one of the “stamp” buttons Y1 to Y4 is pressed on the stamp selection screen Y ((b) of FIG. 17), a stamp image S1 corresponding to a stamp character string of the selected stamp is displayed on the electronic receipt image G3.

In FIG. 18, as a formal receipt has been issued, the stamp image S1 of “formal receipt issue completed” and the electronic receipt information of an original transaction are both displayed in the portable terminal 7. In FIG. 18, a display region of the stamp image S1 is a header region of the electronic receipt image G3. Format of the character string of the stamp image S1 is one of formats set to display the electronic receipt information.

As the character string of the stamp image S1 may be changed, the character string of the stamp image S1 may be also used in the following cases.
“Point provision completed”
“Parking stub issue completed”
“Completed”

According to the present embodiment, as a mark corresponding to a stamp is displayed on an electronic receipt image, it is possible to suppress repetition (for example, double issuing of a receipt) of specific processing (for example, stamp processing with issuing a receipt).

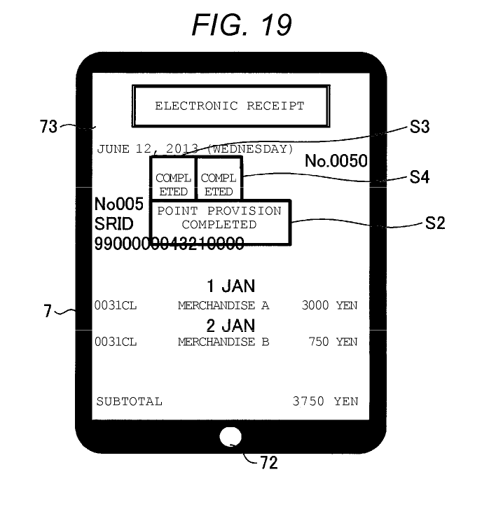

In the present embodiment, as illustrated in FIG. 18, the stamp image (mark) S1 and the electronic receipt image G3 are displayed integrally, but the manner to display the stamp image is not limited thereto. For example, as illustrated in FIG. 19, the stamp processing may be sequentially executed on one electronic receipt information multiple times, and a plurality of stamp images S2 to S4, respectively corresponding to stamp processing which is executed multiple times, may be displayed.

In the above embodiments, the control unit 11 (receipt information output section 112) of the POS terminal 1 converts receipt information into electronic receipt information, but the configuration is not limited thereto. For example, the printer 13 of the POS terminal 1 may execute the conversion processing. Specifically, a print control apparatus (not illustrated), which is included in the printer 13 and controls printing, may serve as the receipt information output section 112. In this case, when it is determined that a member code is not included in receipt information which is generated and input by the control unit 11 (receipt information generation section 111) of the POS terminal 1, the print control apparatus of the printer 13 prints and outputs the receipt information. When it is determined that the member code is included in the receipt information, the print control apparatus of the printer 13 converts the receipt information into electronic receipt information. When it is determined that a member code is included in receipt information, which is dummy print data, based on a stamp character string and the like of the stamp generated and selected by the control unit 11 (receipt information generation section 111) of the POS terminal 1, the print control apparatus of the printer 13 converts the receipt information based on the stamp character string and the like of the selected stamp, into electronic receipt information. The print control apparatus of the printer 13 transmits the generated electronic receipt information to the electronic receipt server 3 through the communication I/F 16 of the POS terminal 1.

In the above embodiments, a member code and the like are obtained using the code scanner 15. However, the configuration is not limited thereto, and the member code and the like may be obtained using other methods. Specifically, the POS terminal 1 and the portable terminal 7 may each include a near field wireless communication unit that performs near field wireless communication, such as a near field communication (NFC) and Bluetooth (registered trademark), and the member code and the like may be transmitted using the near field wireless communication. In this case, the portable terminal 7 stores the member code and the like in the storage unit 75, an IC tag (not illustrated), or the like.

In the above embodiments, the member code and the like are obtained from the portable terminal 7; however, the configuration is not limited thereto. For example, the member code and the like may be obtained from a medium containing the member code, such as an IC card and a magnetic card. When the IC card is used, the POS terminal 1 may include a reading and writing unit such as an IC card reader and writer. When the magnetic card is used, the POS terminal 1 may include a card reader and writer for a magnetic card, and the like.

In the above embodiments, the electronic receipt server 3 is located in the headquarter P2; however, the configuration is not limited thereto. For example, the electronic receipt server 3 for company may be located in the store P1 of the company. In this case, the POS terminal 1 outputs electronic receipt information to the electronic receipt server 3, which is connected to the network N1 in the store P1. The electronic receipt server 3 transmits the electronic receipt information to the electronic receipt management server 4 through the network N1 and the network N2 in the store P1.

In the above embodiments, the electronic receipt information generated by the POS terminal 1 is output to the electronic receipt management server 4 through the electronic receipt server 3; however, the configuration is not limited thereto. For example, the POS terminal 1 may access the electronic receipt management server 4 through the network N3, and the electronic receipt information may be directly output to the electronic receipt management server 4 from the POS terminal 1.

In the above embodiments, the portable terminal 7 receives the electronic receipt information through the electronic receipt management server 4; however, the configuration is not limited thereto. For example, the electronic receipt information may be directly received from the POS terminal 1. In this case, the POS terminal 1 outputs the generated electronic receipt information to the portable terminal 7, which is connected through the network N1 in the store P1 or a near field wireless communication unit (not illustrated). In this case, the authentication processing may be executed by the POS terminal 1.

In the above embodiments, the POS terminal 1 stores the merchandise data file; however, the configuration is not limited thereto. For example, the store server 2 may store the merchandise data file which is referable from the POS terminal 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A server connected to a plurality of store servers and mobile computing devices over a network and configured to generate display data for display units of the mobile computing devices, comprising:
a communication unit configured to receive electronic receipt data from a store server along with a setting that indicates whether or not a mark representing that an electronic receipt has been stamped, is to be overlaid on the electronic receipt when the electronic receipt is displayed on a display unit of the mobile computing device; and
a processing unit configured to generate display data from the electronic receipt data according to the setting, and transmit the display data to a mobile computing device correlated to a user code included in the electronic receipt data, for display by the mobile computing device,
wherein the display data generated by the processing unit includes a first portion corresponding to the display data of the electronic receipt, and, if the setting indicates that the mark is to be overlaid on the electronic receipt, also a second portion corresponding to the display data of the mark.

2. The server according to claim 1, wherein
if the setting indicates that the mark is to be overlaid on the electronic receipt, the communication unit also receives a mark ID of the mark to be overlaid form the store server,
if a first mark ID is received, the generated display data includes the display data of a first mark in the second portion, and
if a second mark ID is received, the generated display data includes the display data of a second mark that is different from the first mark in the second portion.

3. The server according to claim 2, further comprising:
a storage unit storing a table including one or more entries, each including a receipt ID of the electronic receipt data, the corresponding setting, and if the setting indicates that the mark is to be overlaid on the electronic receipt, the mark ID, wherein
the display data of the second portion is generated based on an entry in the table.

4. The server according to claim 1, wherein
the electronic receipt data further includes a product ID of a product purchased through a purchase transaction corresponding to the electronic receipt data,
the setting is associated with the product ID of the purchased product, and
if the setting indicates that the mark is to be overlaid on the electronic receipt, the display data of the mark in the second portion causes the mark to be overlaid on or adjacent to characters representing the associated product in the electronic receipt.

5. The server according to claim 1, wherein
the setting is a flag attached to the corresponding receive electronic receipt data.

6. The server according to claim 1, wherein
the mark indicates that a product included in the electronic receipt has been returned.

7. The server according to claim 1, wherein
the mark indicates that a parking stub has been provided for a purchase transaction corresponding to the electronic receipt.

8. The server according to claim 1, wherein
the mark indicates that a reward gift has been provided for a purchase transaction corresponding to the electronic receipt.

9. The server according to claim 1, wherein
the mark indicates that a reward gift has been provided for purchase transaction corresponding to the electronic receipt.

10. A method for generating display data for display units of the mobile computing devices, comprising:
receiving electronic receipt data from a store server along with a setting that indicates whether or not a mark representing that an electronic receipt has been stamped, is to be overlaid on the electronic receipt when the electronic receipt is displayed on a display unit of the mobile computing device;
generating display data from the electronic receipt data according to the setting; and
transmitting the display data to a mobile computing device correlated to a user code included in the electronic receipt data, for display by the mobile computing device, wherein
the display data generated by the processing unit includes a first portion corresponding to the display data of the electronic receipt, and, if the setting indicates that the mark is to be overlaid on the electronic receipt, also a second portion corresponding to the display data of the mark.

11. The method according to claim 10, wherein
if the setting indicates that the mark is to be overlaid on the electronic receipt, a mark ID of the mark to be overlaid is also received from the store server,
if a first mark ID is received, the generated display data includes the display data of a first mark in the second portion, and
if a second mark ID is received, the generated display data includes the display data of a second mark that is different from the first mark in the second portion.

12. The method according to claim 11, further comprising:
storing a table including one or more entries, each including a receipt ID of the electronic receipt data, the corresponding setting, and if the setting indicates that the mark is to be overlaid on the electronic receipt, the mark ID, wherein
the display data of the second portion is generated based on an entry in the table.

13. The method according to claim 10, wherein
the electronic receipt data further includes a product ID of a product purchased through a purchase transaction corresponding to the electronic receipt data,
the setting is associated with the product ID of the purchased product, and
if the setting indicates that the mark is to be overlaid on the electronic receipt, the display data of the mark generated in the second portion causes the mark to be overlaid on or adjacent to characters representing the associated product in the electronic receipt.

14. The method according to claim 10, wherein
the setting is a flag attached to the corresponding receive electronic receipt data.

15. The method according to claim 10, wherein
the mark indicates that a product included in the electronic receipt has been returned.

16. The method according to claim 10, wherein
the mark indicates that a parking stub has been provided for a purchase transaction corresponding to the electronic receipt.

17. The method according to claim 10, wherein
the mark indicates that a reward gift has been provided for a purchase transaction corresponding to the electronic receipt.

18. The method according to claim 10, wherein
the mark indicates that a reward gift has been provided for purchase transaction corresponding to the electronic receipt.
